(19) United States
(12) Patent Application Publication
(10) Pub. No.: US 2026/0364902 A1
(43) Pub. Date: Nov. 19, 2026

(54) Grinding System for Repairing Composite Structures

(71) Applicant: Alfred Crabtree, Pikeville, TN (US)

(72) Inventor: Alfred Crabtree, Pikeville, TN (US)

(21) Appl. No.: 19/677,112

(22) Filed: May 14, 2026

Related U.S. Application Data
(60) Provisional application No. 63/805,426, filed on May 14, 2025.

(51) Int. Cl. B29C 73/24; B24B 49/00; B24B 49/12; B24B 55/06; B29C 73/26

(52) U.S. Cl. CPC B29C 73/245; B24B 49/006; B24B 49/12; B24B 55/06; B29C 2073/262

(57) ABSTRACT

A grinding system for repairing a composite structure includes a grinding wheel operable to grind a surface of the composite structure when rotated. A drive system is operable to rotate and move the grinding wheel relative to the surface of the composite structure. A camera system having one or more cameras is provided for capturing images of the surface of the composite structure as the surface is being grinded by the grinding wheel. A controller is configured to control the drive system for adjusting a rotational speed and position of the grinding wheel relative to the surface of the composite structure based on the captured images of the camera system.

### CROSS REFERENCE TO RELATED APPLICATION

This application claims priority to co-pending U.S. Provisional Application Ser. No. 63/805,426 filed May 14, 2025, entitled “Grinding System for Wind Turbine Blade Repair,” the entire contents of which is incorporated herein by reference.

### FIELD

This disclosure relates generally to a grinding system for repairing composite structures. More particularly, this disclosure relates to a grinding system for performing a stepped grinding operation on a damaged surface of a composite structure such as wind turbine blades.

### BACKGROUND

Damaged wind turbine blades can lead to varying levels of downtime for a wind turbine. Minimizing downtime is crucial to maximizing energy output for the turbine. However, one common and consistent issue in the blade repair industry is the lack of supply of competent composite repair technicians. In this regard, it is difficult to maintain a team of technicians who can perform repairs on the blades profitably due to the high attrition in this field. Further, it takes special and highly skilled technicians to be able to execute high quality repairs in the difficult conditions required in repairing wind turbine blades.

In particular, wind turbine scarfing is a repair technique where damaged surface material/laminate of a wind turbine blade (e.g., cracks, fiber failure, or delamination) is removed by grinding at a shallow, tapered angle before new laminate material is applied to the area being repaired. During scarfing, a technician grinds out the damaged area and bevels the surrounding edges to create a tapered or stepped surface using basic angle grinders. In this regard, the main challenges associated with the grinding step of the blade repair process is the precise control required to be able to remove single layers of fiberglass at one time without damaging the fibers from the layers beneath. For any given repair, the damaged sections must be completely removed but the surrounding material must be “scarfed” by removing layers in a stepped pattern that is then patched with corresponding stepped fabrics to enable a structural repair that can effectively transfer load across the repair surface. This stepwise grinding pattern requires precise control such that for a given area, for example, four layers of fiberglass are removed, then adjacent to that, three layers are removed, adjacent to that two layers are removed, and finally adjacent to that one layer is removed.

Once the grinding process is complete, a new “patch” of composite material is added to the tapered area, with each layer of the patch applied to match the beveled edges. While scarf joints are preferred over other repair methods because the new material of the patch allows for effective load transfer between the old and new material (i.e., weak or inconsistent spots are avoided), the grinding portion of the scarfing process requires highly trained technicians and requires such technicians to be in difficult and dangerous operating conditions to perform the necessary grinding. More specifically, trained technicians must be very careful not to over or under-grind the intended bevel pattern, which could result in an improper repair that could itself damage the blade further or the poorly performing repair could fail in operation and further damage the blade.

What is needed therefore is technology that can make the technicians more productive and potentially reduce the amount of training needed for them to be highly productive in the grinding process.

### SUMMARY

The above and other needs are met by a grinding system for repairing a composite structure. The grinding system includes a grinding wheel operable to grind a surface of the composite structure when rotated and a drive system for rotating and moving the grinding wheel relative to the surface of the composite structure. The grinding system further includes a camera system having one or more cameras for capturing images of the surface of the composite structure as the surface is being grinded by the grinding wheel. A controller is configured to control the drive system for adjusting a rotational speed and position of the grinding wheel relative to the surface of the composite structure based at least in part on the captured images of the camera system.

According to certain embodiments, the grinding system includes a shroud housing for covering the grinding wheel and drive system. The shroud housing includes an outlet configured to be fluidly connected to a vacuum pump for collecting particulates being grinded from the surface of the composite structure. In some embodiments, the shroud housing further includes an inlet open to the atmosphere surrounding the shroud housing, the inlet having a valve for adjusting a vacuum pressure within the shroud housing by adjusting a flow rate of atmospheric air permitted to flow through the inlet and out the outlet. In some embodiments, the outlet and the inlet of the shroud housing are operable to provide a downward force of the grinding wheel against the surface of the composite structure when the outlet is fluidly connected to the vacuum pump.

According to certain embodiments, the grinding system further includes a vision system having one or more light sources for illuminating the surface of the composite structure as the surface is being grinded by the grinding wheel. In some embodiments, the vision system includes a plurality of light sources positioned and configured to illuminate the surface of the composite structure simultaneously at a plurality of different angles.

According to certain embodiments, the drive system includes a first drive wheel and a second drive wheel with the grinding wheel disposed between the first and second drive wheels. In some embodiments, the drive system includes a depth control system for adjusting a depth of the grinding wheel in relation to the first drive wheel and the second drive wheel.

According to certain embodiments, the grinding system further includes a processor in communication with the controller configured to obtain images captured from the camera system for determining damaged areas of the surface of the composite structure and determining optimal repair paths for the grinding wheel.

According to certain embodiments, the grinding system further includes a processor in communication with the controller configured to obtain images captured from the camera system and adjust the rotational speed and feed rate of the grinding wheel based on real-time image analysis.

According to another embodiment of the disclosure, a method of repairing a surface of a composite structure includes providing a grinding system having a grinding wheel operable to grind a surface of the composite structure when rotated, a drive system for rotating and moving the grinding wheel relative to the surface of the composite structure, a camera system having one or more cameras for capturing images of the surface of the composite structure, and a controller configured to control the drive system for adjusting a rotational speed and position of the grinding wheel relative to the surface of the composite structure. The method further includes determining a damaged portion of the surface of the composite structure needing repair; grinding the damaged area of the surface of the composite structure needing repair by rotating and moving the grinding wheel relative to the damaged portion of the surface of the composite structure; capturing images of the damaged area of the surface of the composite structure during the grinding step using the camera system; and adjusting the rotation and movement of the grinding wheel relative to the damaged portion of the surface of the composite structure based at least in part on an analysis of the captured images.

According to certain embodiments, the grinding system further includes a shroud housing for covering the grinding wheel and drive system. The shroud housing includes an outlet, and the method further includes connecting the outlet to a vacuum pump for collecting particulates from the surface of the composite structure during the grinding step. In some embodiments, the shroud housing further includes an inlet open to the atmosphere surrounding the shroud housing. The inlet includes a valve for adjusting a vacuum pressure within the shroud housing, and the method further includes adjusting a flow rate of atmospheric air permitted to flow through the inlet and out the outlet by at least partially opening and closing the valve. In some embodiments, the outlet and the inlet of the shroud housing are operable to provide a downward force of the grinding wheel against the surface of the composite structure when the outlet is fluidly connected to the vacuum pump.

According to certain embodiments, the grinding system further includes a vision system having one or more light sources, and the method further includes illuminating the damaged area of the surface of the composite structure during the grinding and capturing images steps. In some embodiments, the vision system includes a plurality of light sources positioned and configured to illuminate the surface of the composite structure simultaneously at a plurality of different angles during the grinding and capturing images steps.

According to certain embodiments, the drive system includes a first drive wheel and a second drive wheel with the grinding wheel disposed between the first and second drive wheels. In some embodiments, the drive system includes a depth control system for adjusting a depth of the grinding wheel in relation to the first drive wheel and the second drive wheel, and the adjusting step further includes adjusting the depth of the grinding wheel relative to the damaged portion of the surface of the composite structure based at least in part on an analysis of the captured images.

According to certain embodiments, the grinding system further includes a processor in communication with the controller, and the method further includes the processor obtaining images captured from the camera system and determining the damaged area of the surface of the composite structure based on the images captured from the camera system prior to grinding the damaged area. In some embodiments, the method further includes generating a repair plan based on the obtained images captured from the camera system after determining the damaged area of the surface of the composite structure.

### BRIEF DESCRIPTION OF THE DRAWINGS

Other embodiments of the disclosure will become apparent by reference to the detailed description in conjunction with the figures, wherein elements may not be to scale so as to more clearly show the details, wherein like reference numbers indicate like elements throughout the several views, and wherein:

FIG. 1 depicts a bottom perspective view from a first end of a grinding system according to one embodiment of the disclosure.

FIG. 2 depicts an overhead perspective view from a second end of the grinding system according to one embodiment of the disclosure.

FIG. 3 depicts an overhead perspective view from the second end of the grinding system having a shroud housing according to one embodiment of the disclosure.

### DETAILED DESCRIPTION

The present disclosure provides an enhanced grinding system intended to be utilized by a technician to dramatically simplify the grinding process of damaged wind turbines blades. The system puts advanced precision grinding capability into the hands of technicians. Generally, the grinding system of the present disclosure incorporates a grinding wheel operatively connected to a powered drive system for moving the grinding wheel in a controlled and precise manner along the blade surface. The drive system preferably moves the grinding wheel approximately 1 cm/s along the blade surface while allowing the grinding wheel to remove material using clockwise or counterclockwise rotations as needed. The drive system further provides precise depth control of the grinding wheel during operation.

The grinding system of the present disclosure preferably also incorporates a vacuum system to capture grinding dust. The vacuum created by the vacuum system also helps the technician by providing a downward force on the grinding wheel against the blade surface being repaired.

The grinding system of the present disclosure preferably also incorporates a vision system operable to provide an array of high intensity light sources from different angles on the blade surface being repaired in conjunction with a camera system used to monitor and magnify the blade surface to assist the technician by providing enhanced visualization of the fiberglass layer removal as it progresses. Effectively viewing the grinding process in real time is critical to success of the blade repair and takes significant training to perform an adequate repair in large part due to the translucent fiberglass layers of the blade being repaired. Thus, the array of high intensity lights assists the technician in interpreting the top layer portions being scarfed during the repair process. The camera system enhances this visual effect, and also allows technicians on the ground to view the process in real time and provide assistance as needed.

While the grinding system of the present disclosure is described herein as being intended specifically for repairing wind turbine blades, it should be understood that the grinding system may also be advantageously utilized in other applications involving the repair of similarly engineered composite structures or structures otherwise needing repair in part by grinding a surface of the structure, particularly in difficult and dangerous repair conditions. Contemplated potential applications include, but are not limited to, civil infrastructure (e.g., bridge/deck repair), maritime maintenance, and pipeline integrity.

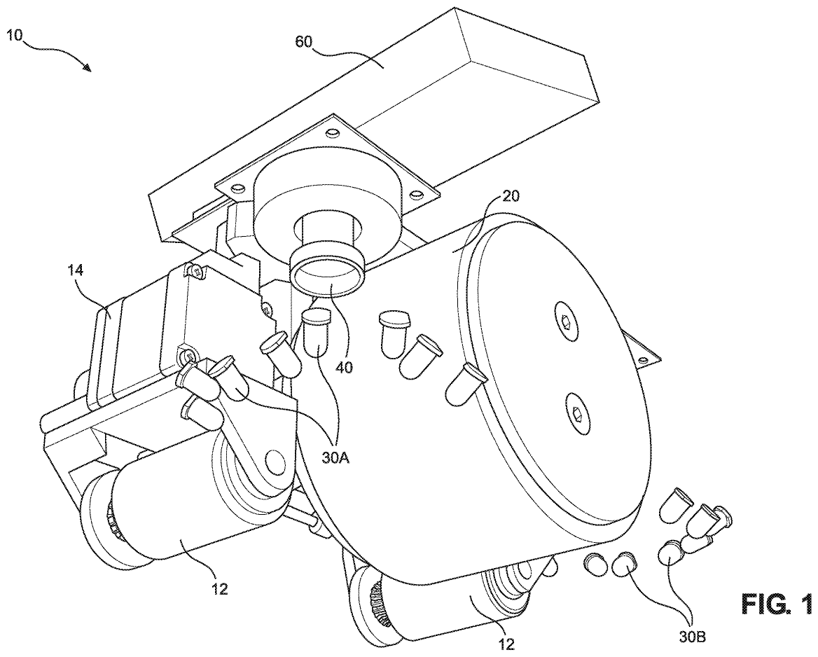

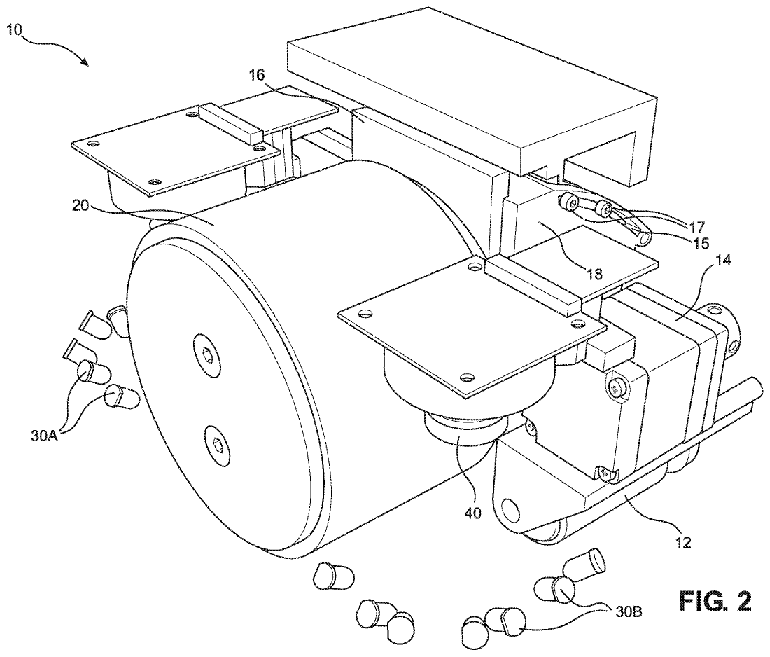

With reference to FIGS. 1-2, an exemplary grinding system 10 of the present disclosure generally includes one or more abrasive grinding wheels 20 operable to be rotated and driven by a drive system. The drive system includes one or more drive wheels 12 operatively controlled by corresponding drive wheel motors 14. As shown best in FIG. 1, a singular grinding wheel 20 is preferably disposed between two drive wheels 12. The drive wheels 12 are positioned and configured to drive along the surface of a wind turbine blade being repaired while the grinding wheel 20 performs the material removal of the damaged portion of the wind turbine blade. The drive system further includes a grinding wheel motor assembly such as a planetary gear box controlled by an axially located motor for rotating the grinding wheel 20 in a controllable fashion. Various grinding wheels 20 of different diameters, widths, profiles, and abrasive qualities may be utilized depending on job requirements and technician preferences. The grinding system 10 is preferably configured such that wheels 20 of different configurations may be utilized interchangeably as desired. The grinding wheel motor assembly and drive wheel motors 14 is preferably reversible such that the grinding wheel 20 and drive wheels 12 are operable to be rotated in either a clockwise or counterclockwise configuration.

As noted above, the grinding system 10 is meant to operate laterally in either direction, with upcutting or downcutting with the grinding wheel 20 controlled by (1) the rotational direction of the grinding wheel 20 as a result of the motor rotational direction provided by the grinding wheel motor assembly; and/or (2) the direction of rotation of the drive wheels 12 as a result of the motor direction provided by the drive wheel motors 14.

In addition to moving laterally along a top surface of the blade being repaired, the grinding system 12 preferably also includes the ability to control depth of the grinding wheel 20 with respect to the drive wheels 12. For example, according to certain embodiments and as shown best in FIG. 2, the grinding wheel 20 is connected to a motor plate 16. The motor plate 16 is operatively connected to a tilt plate 18 (e.g., a U-shaped or curved bracket) having curved channels 15 disposed on opposing sides of the plate 18. Guide pins 17 are disposed within the channels 15 and operatively connected to a motor and the motor plate 16. Thus, as the guide pins 17 move along the curved channels 15, the motor plate 16 is operable to be raised and lowered with respect to the tilt plate 18 for adjusting the depth of the grinding wheel 20.

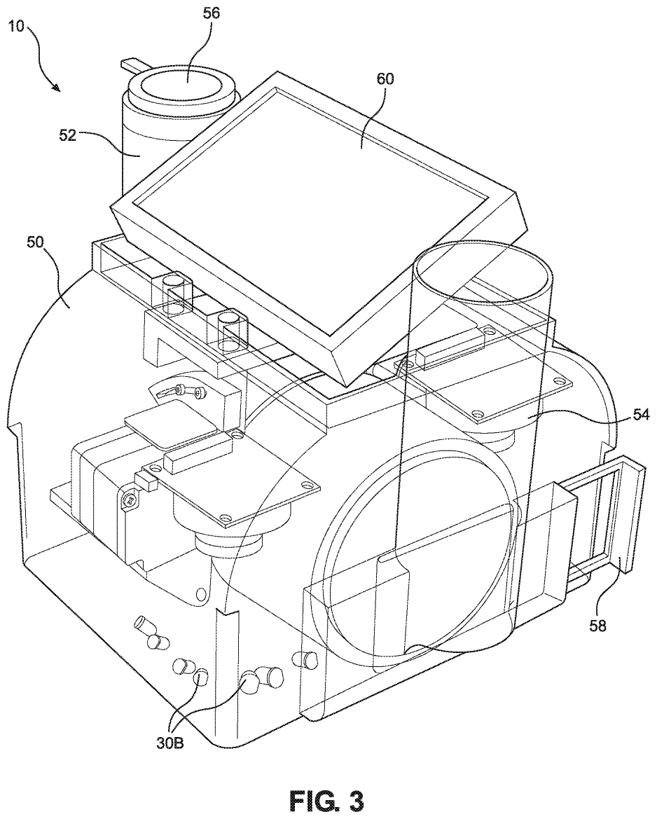

With continued reference to FIGS. 1-2, the grinding system 10 further includes a vision system having a light source for illuminating the surface of the blade being repaired around the grinding wheel 20. The vision system is preferably formed of one or more light-emitting diode (LED) arrays. As depicted in FIG. 1, the grinding system 10 of the present disclosure includes a first LED array 30A and a second LED array 30B each disposed on opposite sides of the grinding wheel 20 (FIG. 1 depicts the LED arrays 30A and 30B as “floating” but it should be understood that the arrays would be supported by a housing such as shown in FIG. 3 and/or related framing system within the housing). A camera system having one or more cameras 40 is positioned and configured to capture and record the surface of the wind turbine blade being repaired. Together, the vision system and camera system aid with the determination of fiber direction and current layer removal.

According to certain embodiments, and particularly in connection with repair of fiberglass or similar composite structures, the vision system is operable to shine different light sources off the surface of the fibers to assist the technician and/or an automated grinding system to determine the fiber direction of the structure being repaired. In this regard, without being bound by any particular theory, it is believed that there is phenomenon where the fibers of a wind turbine blade are visibly brighter at certain angles when the surface is illuminated with a light source. Thus, to distinguish between different fiber directions (e.g., 0°, +45°, and −45° fiber directions) during the repair process, the vision system may be configured to shine different light sources off the fibers in different directions, which in turn indicates the current layer of fiberglass being removed by the grinding system during the grinding process. Further, the camera system is preferably provided to enhance this visual effect and also allow technicians on the ground to view the process in real time and provide assistance as needed.

With reference to FIG. 3, the grinding system 10 further includes a shroud housing 50 having an inlet 52 and an outlet 54. The outlet 54 is dimensioned and configured to be fluidly connected to a vacuum pump (not shown) for both capturing/extracting grinding dust and particulates through the housing 50 and to provide a downward force on the grinding wheel against the blade surface being repaired. The inlet 52 is open to the atmosphere for maintaining the flow of air through the shroud housing 50 while the vacuum pump is pulling in air through the outlet 54. The inlet 52 preferably includes a bypass valve 56. The valve 56 permits the technician to control the amount of atmospheric air that bypasses the shroud housing 50. In an open position, the valve 56 facilitates air flow through the housing 50 for enhancing dust removal through the outlet 54 (which reduces downward force on the grinding wheel). In a closed position, the valve 56 reduces air flow through the housing, which reduces the amount of dust removal through the outlet 54 but enhances downward force on the grinding wheel 20. The bypass valve 56 may also be incrementally adjusted between the open and closed positions to adjust the air flow as desired. Additionally, a dust collector slide 58 may be disposed between the interior of housing 50 and the outlet 54 for adjusting the air flow through the housing created by the vacuum pump. For example, the slide may be positioned adjacent the grinding wheel 20 as depicted in FIG. 3 such that the suction created by the vacuum pump may be biased to a particular side of the grinding wheel 20 in order to maximize dust extraction at the location in which grinding wheel 20 is cutting the surface of the blade at a particular time.

With continued reference to FIG. 3, the shroud housing 50 serves multiple functions in addition to collecting/extracting dust. In particular, as noted above, the vacuum created in the shroud housing 50 also provides downward force, which couples the grinding system 10 to the blade/work surface being grinded. The downward force can be varied by the vacuum bypass valve 56. The advantage to the technician of this feature cannot be overstated. Repetitive stress injuries, fatigue, quality issues, are drastically reduced with this feature as the as the amount of force required by the technician to maintain the positioning of the grinding wheel against the blade surface being repaired is significantly reduced. Additionally, the shroud housing 50 preferably provides the interface 60 for the hand controls, the lights and camera systems, and the microcontroller and display components. The interface 60 preferably includes a touchscreen as best depicted in FIG. 3.

According to another aspect of the disclosure, each of the components of the grinding system 10 described herein are operable to be controlled via a controller incorporated into the control interface 60. The interface 60 further includes a transceiver that is preferably operable to have Bluetooth, WiFi, or other remote communication capabilities to provide communication to a remote technician station (e.g., a station disposed at the base of the turbine being repaired) to provide remote monitoring and/or telemetry in real time of all channels of controls and video output from the grinding system 10 during the grinding process. According to certain embodiments, the control interface 60 (or an additional control interface) may also be provided remotely such that the grinding process may be controlled remotely using the vision and camera systems described herein.

According to another aspect of the disclosure, the vision and camera system described herein are operable to provide real time telemetry regarding the characteristics of the grinding operation as it takes place (e.g., identifying material layers and depth in real-time). A processor is configured to process images from the cameras to identify damaged areas and determine optimal repair paths. Data collected during a repair may also be used for process validation of technicians being trained. Further the data may be used to provide the digital foundation for autonomous grinding operations. In other words, it is foreseen that algorithms will be developed (whether by humans or machine learning programs) for autonomously using the grinding system 10 of the present disclosure using the real-time data of a particular repair as it is being performed based on historical data collected from past repairs using the grinding system 10.

The foregoing description of preferred embodiments for this disclosure have been presented for purposes of illustration and description. They are not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by any claims when interpreted in accordance with the breadth to which they are fairly, legally, and equitably entitled.

What is claimed is:

1. A grinding system for repairing a composite structure, the grinding system comprising:
a grinding wheel operable to grind a surface of the composite structure when rotated;
a drive system for rotating and moving the grinding wheel relative to the surface of the composite structure;
a camera system having one or more cameras for capturing images of the surface of the composite structure as the surface is being grinded by the grinding wheel; and
a controller configured to control the drive system for adjusting a rotational speed and position of the grinding wheel relative to the surface of the composite structure based at least in part on the captured images of the camera system.

2. The grinding system of claim 1 further comprising a shroud housing for covering the grinding wheel and drive system, the shroud housing including an outlet configured to be fluidly connected to a vacuum pump for collecting particulates being grinded from the surface of the composite structure.

3. The grinding system of claim 2 wherein the shroud housing further includes an inlet open to the atmosphere surrounding the shroud housing, the inlet including a valve for adjusting a vacuum pressure within the shroud housing by adjusting a flow rate of atmospheric air permitted to flow through the inlet and out the outlet.

4. The grinding system of claim 3 wherein the outlet and the inlet of the shroud housing are operable to provide a downward force of the grinding wheel against the surface of the composite structure when the outlet is fluidly connected to the vacuum pump.

5. The grinding system of claim 1 further comprising a vision system having one or more light sources for illuminating the surface of the composite structure as the surface is being grinded by the grinding wheel.

6. The grinding system of claim 5 wherein the vision system includes a plurality of light sources positioned and configured to illuminate the surface of the composite structure simultaneously at a plurality of different angles.

7. The grinding system of claim 1 wherein the drive system includes a first drive wheel and a second drive wheel with the grinding wheel disposed between the first and second drive wheels.

8. The grinding system of claim 7 wherein the drive system includes a depth control system for adjusting a depth of the grinding wheel in relation to the first drive wheel and the second drive wheel.

9. The grinding system of claim 1 further comprising a processor in communication with the controller configured to obtain images captured from the camera system for determining damaged areas of the surface of the composite structure and determining optimal repair paths for the grinding wheel.

10. The grinding system of claim 1 further comprising a processor in communication with the controller configured to obtain images captured from the camera system and adjust the rotational speed and feed rate of the grinding wheel based on real-time image analysis.

11. A method of repairing a surface of a composite structure, comprising:
providing a grinding system including:
a grinding wheel operable to grind a surface of the composite structure when rotated,
a drive system for rotating and moving the grinding wheel relative to the surface of the composite structure,
a camera system having one or more cameras for capturing images of the surface of the composite structure, and
a controller configured to control the drive system for adjusting a rotational speed and position of the grinding wheel relative to the surface of the composite structure,
determining a damaged portion of the surface of the composite structure needing repair;
grinding the damaged area of the surface of the composite structure needing repair by rotating and moving the grinding wheel relative to the damaged portion of the surface of the composite structure;
capturing images of the damaged area of the surface of the composite structure during the grinding step using the camera system; and
adjusting the rotation and movement of the grinding wheel relative to the damaged portion of the surface of the composite structure based at least in part on an analysis of the captured images.

12. The method of claim 11 wherein the grinding system further includes a shroud housing for covering the grinding wheel and drive system, wherein the shroud housing includes an outlet, and wherein the method further comprises connecting the outlet to a vacuum pump for collecting particulates from the surface of the composite structure during the grinding step.

13. The method of claim 12 wherein the shroud housing further includes an inlet open to the atmosphere surrounding the shroud housing, wherein the inlet includes a valve for adjusting a vacuum pressure within the shroud housing, and wherein the method further comprises adjusting a flow rate of atmospheric air permitted to flow through the inlet and out the outlet by at least partially opening and closing the valve.

14. The method of claim 13 wherein the outlet and the inlet of the shroud housing are operable to provide a downward force of the grinding wheel against the surface of the composite structure when the outlet is fluidly connected to the vacuum pump.

15. The method of claim 11 wherein the grinding system further includes a vision system having one or more light sources, and wherein the method further comprises illuminating the damaged area of the surface of the composite structure during the grinding and capturing images steps.

16. The method of claim 15 wherein the vision system includes a plurality of light sources positioned and configured to illuminate the surface of the composite structure simultaneously at a plurality of different angles during the grinding and capturing images steps.

17. The method of claim 11 wherein the drive system includes a first drive wheel and a second drive wheel with the grinding wheel disposed between the first and second drive wheels.

18. The method of claim 17 wherein the drive system includes a depth control system for adjusting a depth of the grinding wheel in relation to the first drive wheel and the second drive wheel, and wherein the adjusting step further includes adjusting the depth of the grinding wheel relative to the damaged portion of the surface of the composite structure based at least in part on an analysis of the captured images.

19. The method of claim 11 wherein the grinding system further includes a processor in communication with the controller, and wherein the method further comprises the processor obtaining images captured from the camera system and determining the damaged area of the surface of the composite structure based on the images captured from the camera system prior to grinding the damaged area.

20. The method of claim 19 further comprises generating a repair plan based on the obtained images captured from the camera system after determining the damaged area of the surface of the composite structure.
